(19) United States
(12) Patent Application Publication
(10) Pub. No.: US 2002/0041046 A1
(43) Pub. Date: Apr. 11, 2002

(54) Method and apparatus for making heat-insulative foamed layer containers and making a web of heat-insulative foamed layer material

(75) Inventors: Timothy P. Hartjes, Kimberly, WI (US); Michael A. Breining, Neenah, WI (US); Debra D. Bowers, Menasha, WI (US); Daniel J. Geddes, Appleton, WI (US); Patrick L. Maynard, Combined Locks, WI (US); Louann S. Mueller, Little Chute, WI (US); Robert Patterson, Winneconne, WI (US); Kathleen R. Rigotti, Neenah, WI (US); Rebecca E. Whitmore, Chilton, WI (US)

Correspondence Address: FINNEGAN, HENDERSON, FARABOW, GARRETT &, DUNNER LLP, 1300 I STREET, NW, WASHINGTON, DC, 20005, US

(73) Assignee: Fort James Corporation

(21) Appl. No.: 10/014,159

(22) Filed: Dec. 13, 2001

Related U.S. Application Data
(63) Continuation of application No. 09/425,295, filed on Oct. 25, 1999, now abandoned.
Application No. 09/425,295 is a continuation-in-part of application No. 09/382,199, filed on Aug. 23, 1999, now abandoned.

(51) Int. Cl. B29C 44/24; B29C 44/28; B29C 44/32

(52) U.S. Cl. 264/45.1; 264/45.8; 264/45.9; 264/46.1; 425/446

(57) ABSTRACT

At least one container is disposed in contact with at least one mandrel to cause a thermoplastic polymeric film on the container to foam and become a heat insulative layer. The mandrel is heatable to a predetermined temperature and the container is in direct contact therewith or disposed thereon for a predetermined period of time, to thereby cause the foamable material on the container to foam. A method of making a web of heat insulative nonwoven material includes providing a web of nonwoven material, applying a layer of thermoplastic polymeric material to a first surface of the web to form a web laminate, placing the web laminate in contact with a heated surface, heating the web laminate and thereby expanding the layer of thermoplastic material with moisture that is vaporized from the nonwoven material. The web laminate may then be fabricated to form a container or a portion of a container.

### CROSS-REFERENCE TO RELATED APPLICATION

The present application is a continuation-in-part of U.S. application Ser. No. 09/382,199, filed Aug. 23, 1999.

### TECHNICAL FIELD

The present invention is directed to a method and apparatus for making a heat-insulating paper container having a foamed layer of a thermoplastic polymeric film on at least one surface thereof and for making a web of heat-insulative foamed layer material. More particularly, the present invention is directed to a method and apparatus for placing the container in contact with a heatable mandrel to produce the foamed layer, and to a method of making a web of heat-insulative material having a thermoplastic polymeric material layer on a first surface thereof, whereby the thermoplastic polymeric material layer is expanded to form an insulating layer by placing the web in direct contact with a heated surface or heatable mandrel.

### BACKGROUND OF THE INVENTION

Over the years, heat-insulated disposable containers have been formed in a variety of ways. Thermoformed plastic containers, for instance, are formed by casting the plastic into a mold, heating the plastic under pressure to produce a foam, and then removing the foamed article from the mold. Heat-insulating paper containers, on the other hand are disclosed in U.S. Pat. Nos. 4,435,344 and 5,490,631, the disclosures of which are hereby incorporated by reference herein. Referring to FIG. 1, an example of such a prior art heat-insulating paper container 100 is illustrated. The container 100 generally includes a paper sheet forming a side body 3 and a bottom panel member 5. The side body 3 has a foamed heat-insulating layer 7 which entirely covers the outer surface and which may typically be formed of a thermoplastic polymeric film such as polyethylene. The inner surface of the side body 3 is covered with a film 9 which is made of either a thermoplastic polymer, such as polyethylene, or an aluminum foil. The inner surface of the bottom panel member 5 is laminated with a thermoplastic polymeric film 11. The heat-insulating container 100 is fabricated by means of a cup-forming machine (not shown). First, the outer surface of a paper sheet is extrusion-laminated with a film of a thermoplastic polymer, such as polyethylene. The inner surface of the paper sheet is also laminated with a thermoplastic polymeric film or an aluminum foil. A paper sheet for making the bottom panel member is laminated with a thermoplastic polymeric film on only one side. A blank is cut from each of the paper sheets. Using a conventional cup-forming machine, the two blanks are fabricated into a container, with the bottom blank or the bottom panel member being oriented in such a way that the film laminated side faces inward. The above described containers require a substrate which is laminated on both sides to facilitate the formation of a foamed heat-insulating layer. However, such dual lamination can add process complexity and cost to the manufacturing system.

The thus-fabricated untreated container, as described above, is then subjected to a heat treatment in order to cause moisture in the paper to vaporize. For instance, the untreated containers can be heated in an oven at about 120° C. for about 120 seconds. When heating by hot air or electric heat, the conveyance of the containers through the oven is performed by laying the containers en masse onto a metal conveyor belt. The containers may be disposed right side up, but in order to achieve maximum cup stability, the cups are preferably disposed in an inverted state, i.e., supported on their larger-diameter rims. As the containers pass through the oven, they are subjected to air currents and conveyor vibrations which may cause the very light-weight containers to be displaced against one another, whereby they can become stuck together. Some containers may be displaced to such an extent that they fall over, whereby jams can occur during conveyance.

Furthermore, it is desirable that all of the containers be subjected to essentially the same treatment in the oven, in order that the foaming action be uniform from one container to another. However, the heating chamber of a typical oven does not provide uniform conditions throughout. That is, in one region of the heating chamber the temperature and/or air current may be different from that of another region. If the containers are being fed through the oven along separate paths (e.g., containers seated on respective opposite sides of the conveyor belt will travel along paths that are laterally spaced from one another), the foaming action may not occur uniformly from one container to another. In an attempt to alleviate that problem, multi-zone ovens have been designed which establish zones of mutually different treatment characteristics, e.g., the temperature, direction of heat flow, and/or direction of air current may intentionally be varied from one zone to another, in an effort to make the overall treatment more uniform among the containers. However, such multi-zone ovens may not adequately achieve that goal and may be more expensive and/or difficult to construct.

In some instances, it may also be desirable to selectively foam only certain areas of the laminated container, such as the area adjacent the upper rim and the middle sidewalls where a user would grip the container, or to provide selected patterns of foamed areas. When conveying the containers through an oven, however, selectively heating only certain areas of the containers is not easily achieved.

Accordingly, there exists a need for a system for foaming thermoplastic polymeric film areas on containers that alleviates the problems associated with containers that become displaced, provides uniform heating and thus uniform foaming, and which allows selective heating of only certain areas. There is also a need for a method of making a web of heat-insulative foamed material so as to avoid the disadvantages associated with variations in oven temperatures, and which may be formed from a paper sheet material which does not require lamination on both surfaces thereof so as to avoid the additional manufacturing complexities and costs associated therewith.

### SUMMARY OF THE INVENTION

The present invention relates to a method and apparatus for producing heat-insulating composite paper containers. The method involves providing fabricated containers, preferably each having a side body and a bottom panel. At least a portion of each container is formed of paper and is provided on at least one surface with a foamable thermoplastic polymeric film which defines a foamable area of the container. The fabricated containers are placed in contact with a heatable mandrel which heats the fabricated containers at a predetermined temperature and time period sufficient to cause the foamable material to foam under the action of moisture released from the paper. While disposed in direct contact with the heating mandrel, each of the fabricated containers is preferably supported in a manner preventing the fabricated container from making contact with the foamable area of any other fabricated container. The heating mandrel is not subject to the differences in air current temperatures that may be present in other modes of heating, such as in an oven, and thereby provides uniform heating and thus uniform foaming of the selected areas of the container.

The apparatus aspect of the invention comprises a plurality of spaced apart heating mandrels for supporting respective fabricated containers and causing a foamable thermoplastic polymeric material to foam on a surface of each fabricated container. Each mandrel is configured for supporting its respective fabricated container in a firmly held manner, substantially preventing the fabricated container from wobbling relative to its mandrel under the influence of conveyor vibration and/or other factors, and preventing the fabricated container from making contact with any other fabricated container during the foaming process. Preferably, each of the mandrels supports its respective container with a portion extending through a mouth of a respective fabricated container and substantially conforming to a shape of the interior surface of the container.

The present invention further relates to a method of making a web of heat-insulative foamed layer material. The method includes providing a web of nonwoven material, applying a layer of thermoplastic polymeric material to a first surface of the web to form a web laminate, placing the web laminate in contact with a heated surface, heating the web laminate, and thereby expanding the layer of thermoplastic polymeric material with moisture that is vaporized from the nonwoven material. The web laminate having a foamed thermoplastic polymeric material can then be utilized in the formation of a container or a portion of a container.

More particularly, the step of placing the web laminate in contact with a heated surface includes placing a second surface of the web of nonwoven material in direct contact with the heated surface, the second surface being opposite to the first surface on which the layer of thermoplastic polymeric material is applied. Still further, the placing step includes passing the second surface of the web material over a heated drum such that the second surface is in direct contact with the heated drum.

### BRIEF DESCRIPTION OF THE DRAWINGS

These, and other, objects, features and advantages of the present invention will become more readily apparent to those skilled in the art upon reading the following detailed description, in conjunction with the appended drawings, in which:

FIG. 1 is a sectional view taken through a prior art container;

FIG. 2 is a sectional view taken through a similar container manufactured in accordance with the present invention;

FIG. 3 is a side elevational view of a conveying mechanism according to the present invention;

FIG. 4 is sectional view taken through the container shown in FIG. 2 when disposed over the mandrel shown in FIG. 3;

FIG. 5 is a schematic illustration of a layer of thermoplastic polymeric material being extruded onto a web material substrate in accordance with a further embodiment of the present invention;

FIG. 6 is a schematic illustration of the paper laminate being passed over a heated drum; and

FIG. 7 is a cross-sectional view of an example container constructed utilizing the paper laminate of the present invention.

### DETAILED DESCRIPTION OF THE PREFERRED EMBODIMENTS

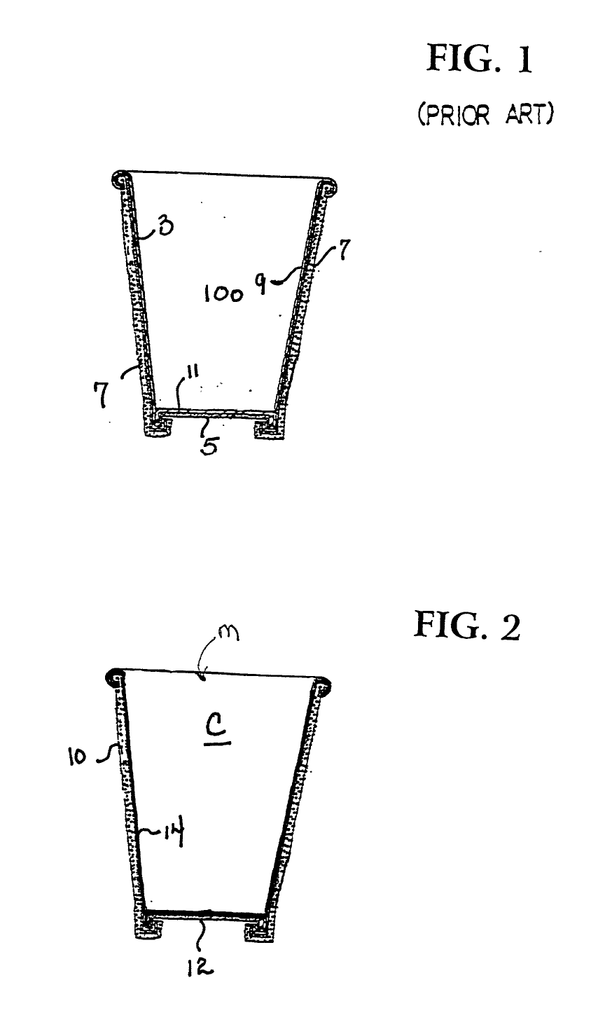

The present invention can be utilized to make a container C that is identical to or generally similar to that depicted in FIG. 1. Referring to FIG. 2, cup C preferably includes an outer side surface 10, a bottom element 12, and an inner side surface 14. The inner side surface 14 preferably includes a paper material or any other type of material capable of releasing moisture vapor when heated. The outer side surface 10 includes a foamable thermoplastic polymeric material or film, preferably low density polyethylene, at least on the portion thereof where heat insulative properties are most desired. It will be appreciated that the steps leading up to the heat treatment of the present invention may be varied within the scope of the invention, as long as the container which is heat treated has a foamable thermoplastic polymeric material on an area thereof, preferably on its outer side surface. As used herein, “foamable thermoplastic polymeric material” refers to a material which is foamable under the action of moisture vapor released from the paper of the container while being treated with heat. The “foamable area” includes the foaming substance itself as well as the portion of the paper on which the foaming substance is disposed.

In utilizing the present invention, conveying methods and apparatus may be provided to ensure that the containers are conveyed such that they do not fall over and the foamable areas of the containers do not contact the foamable areas of other containers. In addition to the heating provided by contact with the mandrel, an oven maybe optionally used to obtain further foaming of the foamable material, if desired.

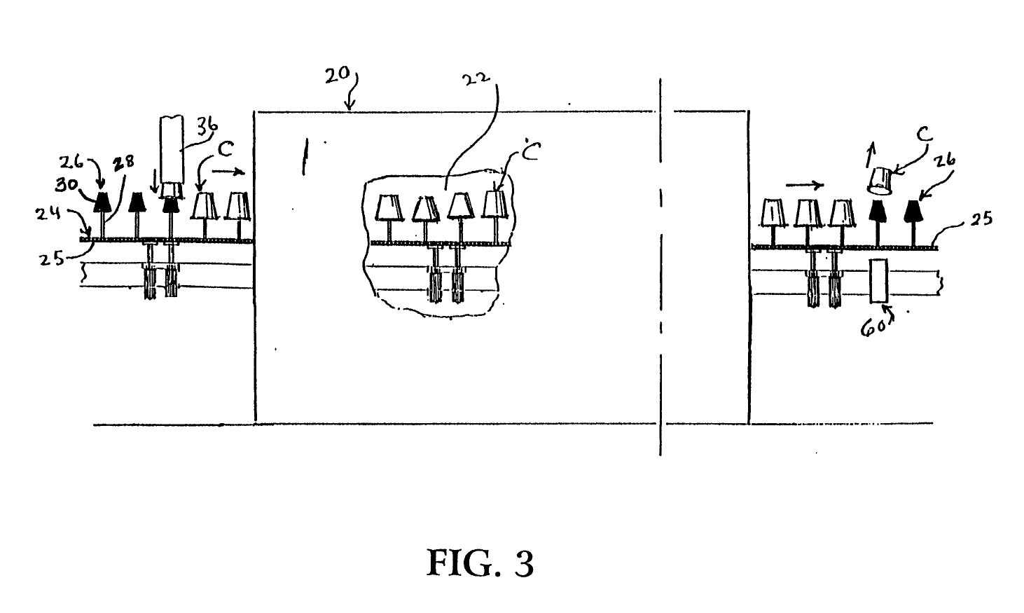

As shown in FIG. 3, a conveyor 24 on which the containers C are supported comprises an endless chain 25 to which are connected container holders in the form of upstanding mandrels 26. Each upstanding mandrel 26 preferably includes a vertical post 28 affixed to the chain 25, and a container supporting section 30. The container supporting section 30 is preferably configured to conform to the inner side of the container. As will be understood by one skilled in the art, the system of FIG. 3 is merely illustrative of one possible embodiment, and the present invention should not be limited thereto. For example, mandrels may take the form of concave structures which contact the outer portion of the respective container when foaming on an inside container surface is desired. In addition, it is within the scope of the present invention to provide any heatable structure which is capable of directly heating a container surface in contact therewith, thereby causing a foamable area of the container to foam.

When a container in a vertical, but inverted, state is inserted downwardly upon the mandrel 26, e.g., by being dispensed from a delivery tube 36, the supporting section 30 extends through a mouth M of the container, and the inside surface of the bottom element 12 comes to rest on the top surface 32 of the supporting section 30, as shown in FIG. 4. The bottom element 12 makes surface contact with the top surface 32 in order to allow for foaming of the bottom panel, if desired, but alternatively, the bottom panel may be recessed downward (i.e., away from the interior of the container C) in order to only make line contact with an outer edge 38 of the top surface of the supporting section 30. The container may also be loaded and unloaded from the mandrel 26 by the use of a vacuum and air pressure such that processing is advantageously increased within a given time period. Alternatively, even though the present invention illustrates the heating mandrels separate from the container forming apparatus, it is also within the scope of the present invention to provide the mandrels associated with the container forming apparatus with appropriate heating capabilities so as to eliminate the need for additional handling of the containers.

The mandrel may be connected to the desired heat source by any suitable method known to one skilled in the art. Suitable methods may include moving contacts such as brushes for an electrical system, permanent contacts obtained by using stationary mandrels, externally heating the mandrels, and the like.

The mandrel 26, including the post 28 and the supporting section 30, is formed of any suitable heat-resistant material, such as aluminum, stainless steel and the like. The post 28 and supporting section 30 can be affixed to one another in any appropriate fashion, e.g., by welding. The mandrel 26, or more preferably, at least the supporting section 30, can be heated by a suitable heat source, for example, electric, steam, induction, hot oil, flame and the like, to a temperature of from about 200° F. to about 500° F., and more preferably, from about 380° F. to about 410° F., when the foamable material of the container C is a low density polyethylene. The foamable areas of the container are considered to foam properly when heat is drawn from the mandrel to the foamable areas. It should be apparent to one skilled in the art that the preferred temperature range would of course vary dependent upon the foamable material to be utilized.

It will be appreciated that the depicted configuration of the supporting section 30 as being a solid mass conforming to the entire interior area of the container represents one of many possible configurations of a supporting section which would achieve the objects of the present invention. Alternatively, it is within the scope of the present invention to have a mandrel which may be expanded or adjustably sized, such as by spring actuation, for example. The supporting section 30 of the present invention merely has to be capable of providing heat to the areas of the container for which foaming is desired. That is, the supporting section 30 may include, for example, an outer peripheral surface having a fanciful pattern or a circumferential band of material disposed in the middle where a user is most likely to grasp the container. In such an instance, only the pattern or the bands will be heated and a container produced on such a supporting section would include a pattern of foamed material corresponding to the fanciful pattern or circumferential band. Thus, the present invention enables only selective portions of the container to be foamed by directly heating only the corresponding selected portions of the supporting section 30.

The containers may be conveyed through an optional oven in addition to being placed on the mandrel, in a single-file serpentine path, or merely conveyed along on the mandrels for a sufficient period of time to achieve the desired foaming action. When no oven is present, the containers have a preferred residence time of approximately 1 to approximately 120 seconds, and more preferably approximately 20 to approximately 40 seconds on mandrels 26, when the mandrels are heated to the above-noted temperatures and the foamable material is low density polyethylene. If an optional oven is utilized, it is preferred for all of the containers to travel along the same path of travel through the heating chamber and to be subjected to virtually identical conditions (e.g., temperature and air flow conditions), regardless of whether conditions in some regions of the heating chamber are different from those in other regions thereof. With the use of an optional oven, the residence time of the containers on the heated mandrels 26 may be reduced. Accordingly, whether or not an oven is utilized, the foaming action occurs uniformly from one container to another, without the need to resort to a special multi-zone oven. The serpentine travel path serves to establish a sufficient residence period for the containers being disposed on the heated mandrels 26 and/or within the oven, while minimizing the required length of the conveyor belt and/or oven. Of course, the provision of a serpentine path is optional. Any travel path could be employed which results in sufficient heating of the containers. For instance the travel path could be straight, with the conveyor belt being long enough to achieve sufficient heating.

Once the containers have exited the oven or are conveyed a sufficient distance to achieve the required residence time disposed upon the heating mandrels, they are ejected from the conveyor chain 25 by a suitable mechanism, such as a blower 60 which emits an upward stream of air that lifts the container off the mandrel, as shown in FIG. 3.

In accordance with the present invention, the containers can be subjected to a foaming action without an oven, if desired, or within an oven for a reduced period of time, without risk that the containers will contact one another, or will cause jams in the conveying line, or will be heated unevenly. Hence, the number of containers that must be sent to waste is reduced, and the need for an operator to shut down a conveying operation and enter an oven in order to overcome container jams is eliminated. Also, the foaming action occurs uniformly from one container to another, avoiding the need to resort to a special multi-zone oven.

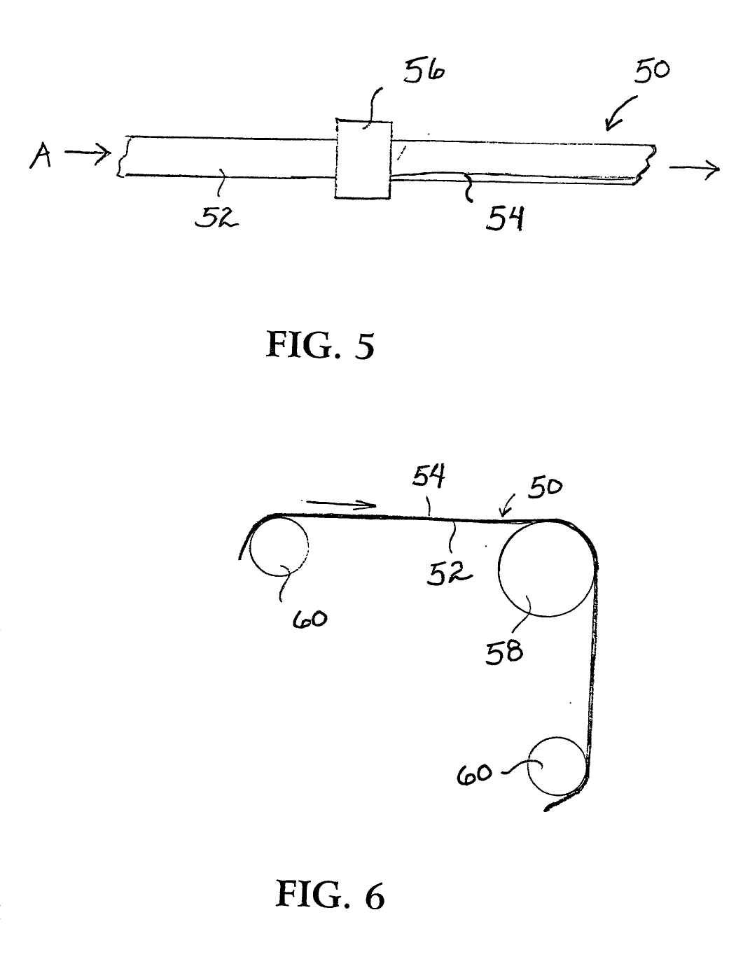

Referring next to FIG. 5, a web of material for use in forming a container in accordance with a further embodiment of the present invention is shown generally by reference numeral 50. The web 50 can be a nonwoven material such as a paper substrate 52, or any other type of material capable of releasing moisture when heated, and a layer of a foamable thermoplastic polymeric material 54 preferably having a softening point approximately corresponding to the boiling point of water. In a preferred embodiment, the paper web is conveyed in a direction “A” and the layer of thermoplastic polymeric material may be extruded from an extrusion die 56 to form a thin film layer on the paper substrate 52. Any other suitable method for applying the layer of thermoplastic material may of course also be used, such as knife-over-roll, spray application, or the like. Thermoplastic polymeric materials or synthetic resins which may be used in the present invention include polyethylene, polypropylene, polyvinyl chloride, polystyrene, polyester, nylon and the like, the term “polyethylene” including low, medium and high density polyethylene. The layer of thermoplastic polymeric material 54 is preferably a low-density polyethylene. The paper substrate 52 may include any desired weight of paper base material ranging from a lightweight sandwich wrap material to paper board material, for example. The paper substrate which is used in the present invention preferably has a basis weight of from about 100 g/m² to about 400 g/m². Moreover, however, the paper substrate can have a moisture content of from about 2% to about 10% and, in order to further enhance the foaming action of the thermoplastic material during the heating process, the paper substrate may also be pre-moisturized, such as by lightly spraying it with water, or otherwise applying water by any conventional means.

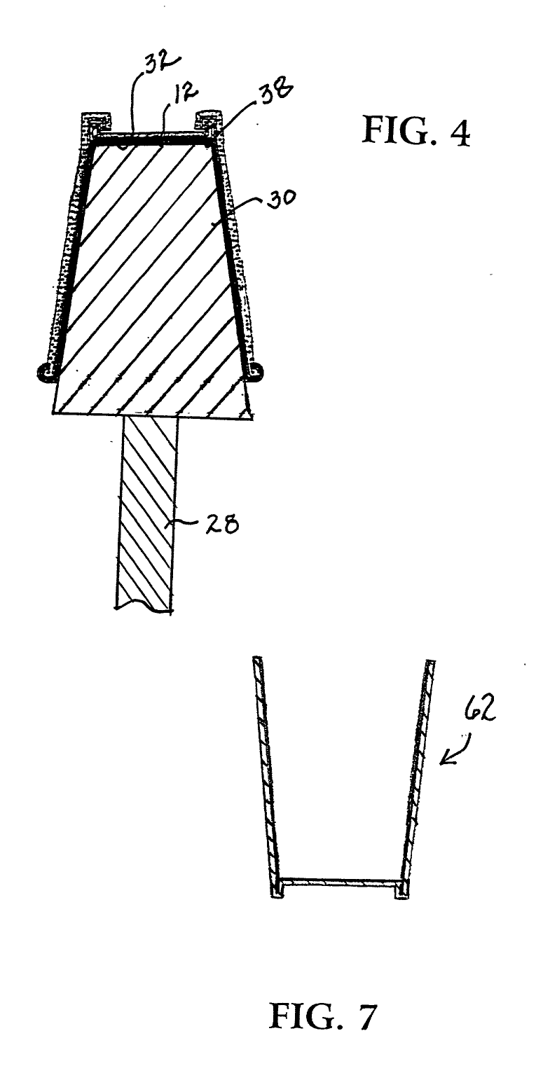

As shown in FIG. 6, after formation of the paper laminate, the web 50 is then conveyed to a drum or roller 58, preferably with the paper substrate 52 side thereof being disposed adjacent to the drum 58. According to the present invention, the drum 58 is heated to form a heated contact surface. Two additional pressure rollers 60 may also be provided to maintain the web in tension and thereby hold the paper laminate in tight contact with the drum. The paper laminate web 50 is conveyed over the heated drum 58 in order to heat the paper substrate 52 to a predetermined temperature and for a time period sufficient to cause the foamable thermoplastic material to foam under the action of the moisture released from the paper substrate 52. That is, as the moisture from the paper is vaporized by the heat, it causes the thermoplastic foam to bubble and expand in caliper. The void spaces thereby produced in the thermoplastic foam provide the insulating properties to the paper laminate web.

The drum 58 can be heated by any suitable heat source, for example, electric, steam, induction, hot oil, flame or any other source. Suitable methods for heating the drum may also include moving contacts such as brushes for an electrical system, permanent contact, externally heating the drum, and the like. The drum is preferably heated to a temperature of from about 200° F. to about 500° F. It should be apparent to one skilled in the art that the preferred temperature range would of course vary dependent upon the foamable thermoplastic material and the moisture content of the paper substrate that are utilized.

The steps leading up to the heat treatment of the paper laminate in the present invention may be varied within the scope of the invention, as long as the web material which is heat treated has a foamable thermoplastic polymeric material on at least one surface area thereof. It is also preferable for the paper substrate surface of the web material to be passed over the heated drum in direct contact therewith. By “foamable” is meant a material which is foamable under the action of moisture vapor released from the paper substrate while being treated with heat.

It will be appreciated that the depicted configuration of the heated drum 58 as being a solid cylindrical mass represents one of many possible configurations of a heated drum which would achieve the objects of the present invention. The heated drum within the scope of the present invention merely has to be capable of providing heat to the areas of the paper laminate for which foaming is desired. That is, the heated drum may include selectively heated regions and, through the use of a strategically located heat sinks, selectively un-heated regions. For example, the drum can have an outer peripheral surface with a fanciful pattern or possibly a central band disposed in the middle where heat-insulative properties are desired in the final end product, wherein only the areas of the pattern or the band will be heated. In such an instance, a paper laminate processed on such a heated drum would include a pattern of foamed material corresponding to the fanciful pattern or central band. Thus, the present invention enables only selective portions of the paper laminate to be foamed by heating only the corresponding selected portions of the heated surface or drum 58. Alternatively, the present invention also envisions foaming selective portions of the paper laminate by allowing only selective contact with a surface of the entirely heated drum 58. Still further, in order to control the foaming of the thermoplastic polymeric material, a pattern of thermoplastic may be chilled instead of being heated such that it will resist foaming when the web laminate and remaining thermoplastic polymeric material is exposed to the heated surface of the drum.

The paper laminate has a preferred residence time of from about 1 to about 120 seconds, and more preferably from about 20 to about 40 seconds on the heated drum, when the drum is heated to the above-noted temperatures and the foamable material is low density polyethylene applied to one surface of the paper substrate. This desired residence time is achieved by using a conveying speed of approximately 50-50,000 ft/min. Optionally, a paper laminate may be coated or layered on both side surfaces with a thermoplastic polymeric material. One advantage of the present invention, however, is that by using a heated contact surface rather than an oven to achieve vaporization of moisture from the paper substrate, it is not necessary to coat or otherwise laminate both surfaces of the web material, thus reducing manufacturing costs. The paper laminate may optionally be conveyed through an oven in combination with the use of the heated drum surface to achieve the desired foaming action. With the use of an optional oven, the residence time of the paper laminate on the heated drum may be reduced. Accordingly, whether or not an oven is utilized, the foaming action occurs uniformly over the desired portions of the web, without the need to resort to a special multi-zone oven.

Once the paper laminate web is conveyed a sufficient distance to achieve the required residence time disposed upon the heated drum, the resulting web material may be used for a variety of purposes. For instance, as shown in FIG. 7, the paper laminate may be used to form an insulated container 62 for use with ice cream, frozen foods, hot meals, and the like.

Further, although the present invention has been described with respect to a paper laminate 50 including a paper substrate 52 and a thermoplastic material layer 54 disposed on one surface thereof, it should be apparent to one skilled in the art that an additional thermoplastic layer may be disposed on the opposing side of the paper substrate. In addition, although discussed above with respect to containers, the insulating material web of the present invention could also be used to form insulated paper wrap materials as well as an insulated sleeve for a cup.

While the present invention has been described with preferred embodiments, it is to be understood that additions, deletions, modification, and substitutions not specifically described may be made without departing from the spirit and scope of the present invention. Such variations and modifications are to be considered within the purview and the scope of the claims appended hereto.

What is claimed is:

1. A method of producing heat-insulating composite paper containers comprising the steps of:
A) providing at least one fabricated container comprised of a side body and a bottom panel, at least a portion of each container formed of paper provided on an area thereof with a foamable thermoplastic polymeric material which defines a foamable area of the container;
B) placing said at least one fabricated container in contact with at least one mandrel; and
C) heating said at least one mandrel with the fabricated container in contact therewith to a temperature and for a time period sufficient to cause the foamable material to foam under the action of moisture vapor released from the paper.

2. The method according to claim 1, wherein step B includes supporting the at least one fabricated container on the at least one mandrel in a manner preventing the foamable area of the at least one fabricated container from making contact with a foamable area of another fabricated container while being conveyed.

3. The method according to claim 2 wherein step C further comprises supporting the at least one fabricated container on its mandrel such that a supporting portion of the mandrel extends through a mouth of the at least one fabricated container.

4. The method according to claim 3 wherein step C further comprises supporting the at least one fabricated container in an inverted state, with the supporting portion of the mandrel extending upwardly through the mouth of the fabricated container.

5. The method according to claim 4 wherein step C further comprises supporting the bottom panel of the at least one fabricated container on an upper end of the supporting portion of the holder.

6. The method according to claim 1 wherein step A further comprises providing an inner surface of the side body with a non-foamable thermoplastic polymeric material.

7. The method according to claim 6 wherein step A further comprises providing an inner surface of the bottom panel of the at least one fabricated container with a non-foamable thermoplastic polymeric material.

8. The method according to claim 1 wherein step A comprises providing a plurality of fabricated containers and step B further comprises conveying the plurality of fabricated containers supported on a plurality of mandrels in single file, along a serpentine path.

9. The method according to claim 1 wherein step A comprises providing a plurality of fabricated containers and step B further comprises conveying the fabricated containers supported on a plurality of mandrels through an oven.

10. The method according to claim 1 wherein step C further comprises heating the mandrel to a temperature of from approximately 200° F. to approximately 500° F.

11. The method according to claim 10 wherein step C further comprises heating the mandrel to a temperature of from approximately 380° F. to approximately 410° F.

12. The method according to claim 1 further comprising removing the at least one fabricated container from the heated mandrels after a predetermined period of time.

13. An apparatus for producing heat-insulating composite paper containers comprising:
a plurality of spaced apart mandrels for receiving a plurality of respective fabricated containers, each mandrel configured for receiving its respective fabricated container, and
at least one of said mandrels having a selectively heatable portion such that a foamable thermoplastic polymeric material portion on a surface of the respective fabricated container will foam.

14. The apparatus according to claim 13 wherein each mandrel supports its respective container in a substantially vertical orientation.

15. The apparatus according to claim 14 wherein each of the mandrels includes a supporting portion extending through a mouth of a respective fabricated container.

16. The apparatus according to claim 15 wherein each mandrel supports its respective fabricated container in an inverted state, with the supporting portion extending upwardly through the mouth of the fabricated container.

17. The apparatus according to claim 16 wherein a bottom panel of each fabricated container is supported directly on an upper end of a respective supporting portion.

18. The apparatus according to claim 13 wherein the heatable portion of the mandrel corresponds to the foamable thermoplastic polymeric material portion on the surface of the fabricated container.

19. The apparatus according to claim 13 wherein each of said plurality of mandrels includes a selectively heatable portion.

20. The apparatus according to claim 13 wherein a size of said mandrel may be adjusted depending on a size of the respective fabricated container.

21. A method of making a web of heat insulative nonwoven material comprising:
providing a web of nonwoven material;
applying a layer of thermoplastic polymeric material to a first surface of the web to form a web laminate;
placing the web laminate in contact with a heated surface;
heating the web laminate and thereby foaming the layer of thermoplastic polymeric material with moisture that is vaporized from the nonwoven material web.

22. The method of claim 21, wherein the thermoplastic polymeric material comprises a low density polyethylene foam.

23. The method of claim 21, wherein said applying step includes extruding the layer of thermoplastic polymeric material onto the web of nonwoven material.

24. The method of claim 21, wherein said placing step includes passing a second surface of the web material over a heated drum such that the second surface is in direct contact with the heated drum.

25. The method of claim 24, further comprising heating the drum to a temperature of at least 200° F.

26. The method of claim 21, wherein said providing a web of nonwoven material step includes providing a paper sheet substrate.

27. The method of claim 26, wherein said providing a paper substrate step includes providing a sandwich wrap material.

28. The method of claim 26, wherein said providing a paper substrate step includes providing a paper board material.

29. The method of claim 21, wherein said heating step includes applying a temperature of at least 200° F. to the web laminate.

30. The method of claim 21, wherein placing the web laminate in contact with a heated surface includes placing a second surface of the web of nonwoven material in direct contact with the heated surface, the second surface being opposite to the first surface on which the layer of thermoplastic polymeric material is applied.

31. The method of claim 21, further comprising the step of fabricating the foamed web laminate into a container or a portion of a container.

32. The method of claim 21, further comprising the step of applying a layer of thermoplastic polymeric material to the second surface of the web.
